(19) United States
(12) Patent Application Publication
(10) Pub. No.: US 2010/0165248 A1
(43) Pub. Date: Jul. 1, 2010

(54) Backlight unit and liquid crystal display device having the same

(76) Inventors: Jung-Hyun Ham, Paju (KR); Heume-Il Baek, Goyang (KR); Jang-Un Kwon, Goyang (KR); Min-Chul Byun, Paju (KR)

Correspondence Address: MCKENNA LONG & ALDRIDGE LLP, 1900 K STREET, NW, WASHINGTON, DC, 20006, US

(21) Appl. No.: 12/654,377

(22) Filed: Dec. 17, 2009

(30) Foreign Application Priority Data
Dec. 31, 2008 (KR) 10-2008-0138676

(51) Int. Cl. G02F 1/13357; G09F 13/04

(52) U.S. Cl. 349/64; 362/97.2; 362/97.3

(57) ABSTRACT

Disclosed are a backlight unit and a liquid crystal display (LCD) device having the same. The backlight unit comprises an optical source for emitting light, a diffusion sheet for diffusing the light incident thereon from the optical source, a first prism sheet for enhancing brightness of the light diffused by the diffusion sheet to be incident thereon by collecting the light to the front side, a second prism sheet for re-collecting the light collected by the first prism sheet to the front side by refraction, and a micro lens film for refracting the light incident thereon from the second prism sheet.

### CROSS-REFERENCE TO RELATED APPLICATION

Pursuant to 35 U.S.C. §119(a), this application claims the benefit of earlier filing date and right of priority to Korean Application No. 10-2008-0138676, filed on Dec. 31, 2008, the content of which is incorporated by reference herein in its entirety.

### BACKGROUND OF THE INVENTION

1. Field of the Invention

The present invention relates to a backlight unit and a liquid crystal display (LCD) device, and particularly, to a backlight unit capable of preventing light from leaking from an in-plane switching (IPS) mode LCD device in a diagonal direction, and an LCD device having the same.

2. Background of the Invention

Recently, with the development of various portable electronic devices, such as mobile phones, PDAs, notebook computers, etc., a light, thin, small flat panel display device has been in great demand. Research and development are actively conducted for the flat panel display devices, such as an LCD, a PDP (Plasma Display Panel), an FED (Field Emission Display), a VFD (Vacuum Fluorescent Display), etc. Among these devices, the LCD attracts much more attention because of its simple mass-production technique, easy driving system, and implementation of a high picture quality.

There are various display modes for the LCD device according to arrangement of liquid crystal molecules. Currently, a TN (twisted nematic) mode LCD device is being generally utilized because of its easy black and white display, short response time, and low driving voltage. When a voltage is applied to the TN mode LCD device, liquid crystal molecules aligned to be horizontal to a substrate are aligned to be nearly perpendicular to a surface of the substrate. Accordingly, there is a problem in that a viewing angle is narrowed by refractive anisotropy of the liquid crystal molecules in applying of the voltage.

In order to solve this problem, LCD devices of various modes having wide viewing angle characteristics have been proposed. Among those, an In-Plane Switch (IPS) mode LCD device is applied to actual mass-production, and thus is being fabricated. This IPS mode LCD device forms a horizontal electric field that is substantially parallel to a surface of a substrate by forming at least one pair of electrodes arranged parallel in a pixel, so that liquid crystal molecules are aligned along the plane.

FIGS. 1A and 1B are a schematic view of a structure of the above-mentioned IPS mode LCD device according to the related art. FIG. 1A is a planar view, and FIG. 1B is a sectional view taken along linen ‘I-I’ in FIG. 1A. As shown in FIG. 1A, a liquid crystal display panel 1 has a pixel defined by a gate line 3 and a data line 4 that are disposed along lengthwise and widthwise directions. Although only the (n, m)^{th} pixel is shown in FIG. 1, N (>n) gate lines 3 and M (>m) data lines are disposed in an actual liquid crystal display panel, thereby forming N×M pixels over the entire liquid crystal display panel 1. A thin film transistor 10 is formed at an intersection of the gate line 3 and the data line 4 in the pixel. The thin film transistor 10 includes a gate electrode 11 to which a scan signal is applied from the gate line 3, a semiconductor layer 12 formed on the gate electrode 11 and activated to form a channel layer when the scan signal is applied thereto, and a source electrode 13 and a drain electrode 14 formed on the semiconductor layer 12, to which an image signal is applied through the data line 4, thereby applying an image signal input from the outside to a liquid crystal layer.

A plurality of common electrodes 5 and a plurality pixel electrodes 7 are arranged substantially parallel to the data line 4 in the pixel. In addition, a common line 16 connected with the common electrode 5 is disposed in the middle of the pixel, and a pixel electrode line 18 connected with the pixel electrode 7 is disposed on the common line 16 and is thus overlapped with the common line 16. As the common line 16 and the pixel electrode line 18 overlap with each other, a storage capacitance is formed at the IPS-mode LCD device.

As discussed above, in the related art IPS mode LCD device, the liquid crystal molecules are aligned substantially parallel to the common electrode 5 and the pixel electrode 7. When the thin film transistor 10 is operated and thus a signal is applied to the pixel electrode 7, a horizontal electric field that is substantially parallel to the liquid crystal display panel 1 is generated between the common electrode 5 and the pixel electrode 7. The liquid crystal molecules are rotated along the same plane by the horizontal electric field, thereby preventing a gradation inversion due to refractive anisotropy.

The related art IPS mode LCD device having such a structure will now be described in more detail with reference to FIG. 1B.

As shown in FIG. 1B, the thin film transistor 10 (in FIG. 1A) includes the gate electrode 11 formed on a first substrate 20, a gate insulating layer 22 laminated over the entire surface of the first substrate 20, the semiconductor layer 12 formed on the gate insulating layer 22, the source electrode 13 and the drain electrode 14 formed on the semiconductor layer 12. In addition, a passivation layer 24 is formed over the entire surface of the first substrate 20. On the passivation layer 24, formed is a first alignment film 28a having a determined alignment direction for aligning liquid crystal molecules to a specific direction by a rubbing process, etc.

The plurality of common electrodes 5 are formed on the first substrate 20 in a pixel, and the pixel electrode 7 and the data line 4 are formed on the gate insulating layer 22, so that a horizontal electric field is generated between the common electrode 5 and the pixel electrode 7.

A black matrix 32 and a color filter layer 34 are formed at a second substrate 30. The black matrix 32 serves to prevent light from leaking to an area where the liquid crystal molecules are not operated (namely, undesired area where an image is not displayed), and is usually formed at the thin film transistor 10 area (in FIG. 1) and between pixels (i.e., gate line and data line areas). The color filter layer 34 includes R (Red), B (Blue) and G (Green) colors to implement an actual color. An overcoat layer 36 may be formed on the color filter layer 34 in order to protect the color filter layer 34 and improve flatness. And, a second alignment film 28b having a determined alignment direction is formed on the overcoat layer 36.

A liquid crystal layer 40 is formed between the first substrate 20 and the second substrate 30, thereby completing the LCD panel 1.

As aforementioned, a horizontal electric field is generated in the liquid crystal layer 40 by the common electrode 5 and the pixel electrode 7 formed on the first substrate 20 and the gate insulating layer 22, respectively. Accordingly, the liquid crystal molecules inside the liquid crystal layer 40 are rotated on the plane, thereby preventing a gradation inversion due to refractive anisotropy of the liquid crystal molecules.

However, the conventional IPS-mode LCD device has the following problems.

Since the liquid crystal molecules are rotated on the same plane along a horizontal electric field, a gradation inversion due to refractive anisotropy of the liquid crystal molecules is prevented. This may enhance viewing angle characteristics in upper and lower directions, or in right and left directions. However, a viewing angle characteristic in a diagonal direction is not enhanced, thereby causing the occurrence of stains (mura) in a diagonal direction of a screen in a Normally Black Mode. The mura mainly occurs at an LCD device having a plurality of light emitting diodes (LEDs) as an optical source, each LED for supplying light to some parts of a liquid crystal display panel.

### SUMMARY OF THE INVENTION

Therefore, an object of the present invention is to provide a backlight unit capable of preventing light from leaking from an in-plane switching (IPS) mode LCD device in a diagonal direction by properly combining optical sheets and polarizers with one another, and an LCD device having the same.

To achieve these and other advantages and in accordance with the purpose of the present invention, as embodied and broadly described herein, there is provided a backlight unit, comprising: an optical source for emitting light; a diffusion sheet for diffusing the light incident thereon from the optical source; a first prism sheet for enhancing brightness of the light diffused by the diffusion sheet to be incident thereon by collecting the light to a front side; a second prism sheet for re-collecting the light collected by the first prism sheet to a front side by refraction; and a micro lens film for refracting the light incident thereon from the second prism sheet.

To achieve these and other advantages and in accordance with the purpose of the present invention, as embodied and broadly described herein, there is also provided a liquid crystal display (LCD) device, comprising: a liquid crystal display panel for displaying an image; a backlight unit for supplying light to the LCD panel, and the backlight unit including an optical source, a diffusion sheet for diffusing the light from the optical source, a first prism sheet for collecting the light to a front side to enhance brightness of the light diffused by the diffusion sheet, a second prism sheet for refracting the light collected by the first prism sheet to re-collect the light to a front side, and a micro lens film for refracting the light from the second prism sheet; a polarizer disposed between the LCD panel and the backlight unit, the polarizer including a zero retardation triacetyl cellulose (TAC) film having no phase difference (Rth); and an analyzer facing the polarizer in which the LCD panel is sandwiched therebetween, the analyzer including a zero retardation TAC film having no phase difference (Rth).

The backlight unit of the present invention may effectively prevent light leakage occurring from an in-plane switching (IPS) mode LCD device in a diagonal direction by properly combining the optical sheets and the polarizers with one another.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B are views showing a structure of an in-plane switching (IPS) mode liquid crystal display (LCDZ) device in accordance with the related art;

FIG. 2 is an exploded perspective view schematically showing a structure of an LCD device;

FIG. 3A is a view showing an absorption axis of upper and lower polarizers when the LCD device is seen from the front side;

FIG. 3B is a view showing an absorption axis of upper and lower polarizers when the LCD device is seen from a diagonal direction;

FIG. 4 is a view showing a structure of an LCD device according to the present invention;

FIG. 5 is a view showing a structure of optical sheets according to a first embodiment of the present invention; and

FIG. 6 is a view showing a structure of optical sheets according to a second embodiment of the present invention.

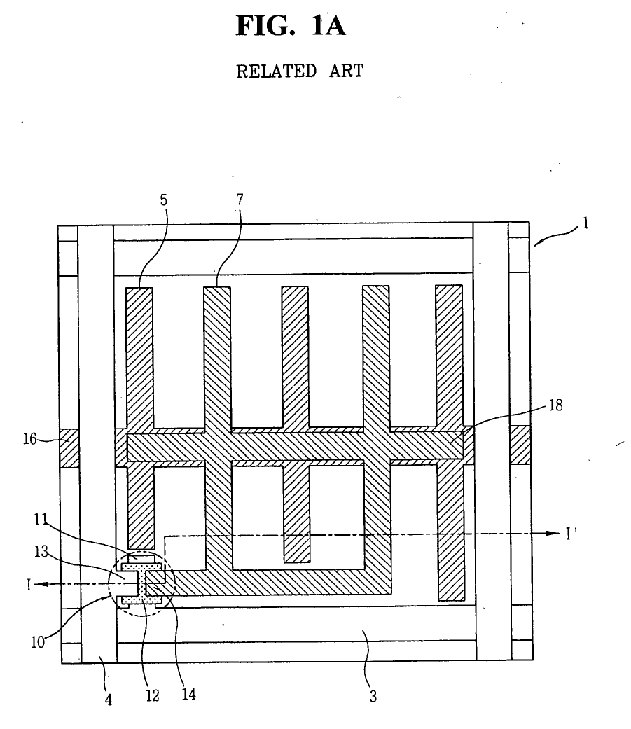

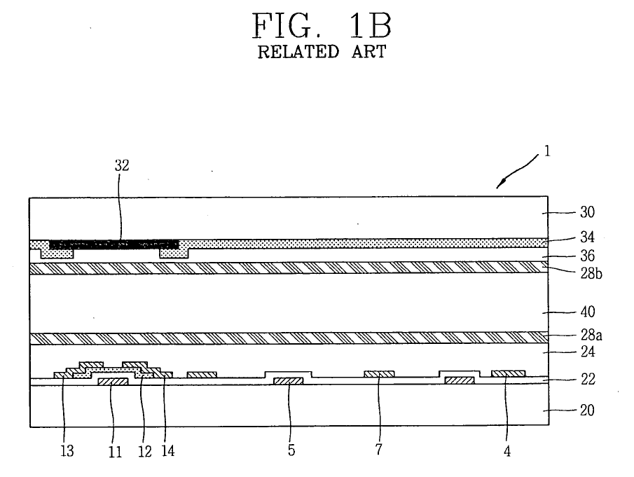

### DETAILED DESCRIPTION OF THE INVENTION

Description will now be given in detail of the present invention, with reference to the accompanying drawings.

Hereinafter, a backlight unit and an LCD device having the same according to the present invention will be explained in more detail with reference to the attached drawings.

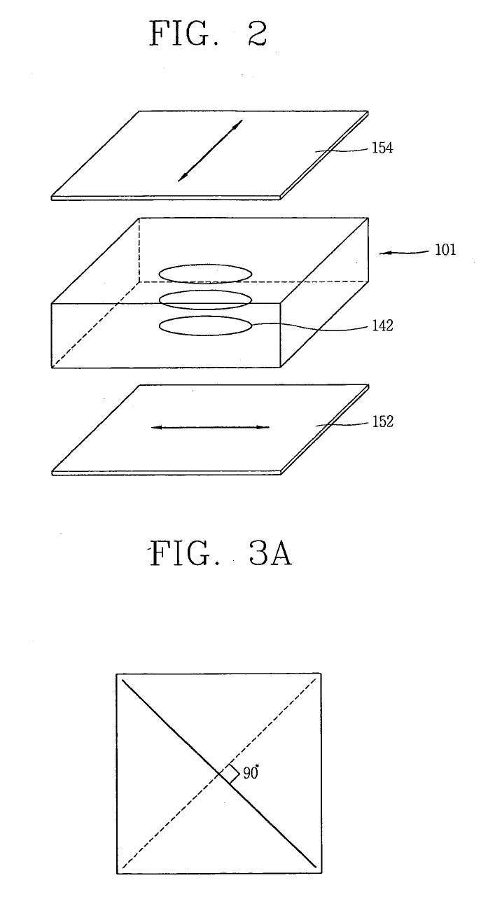

Generally, a viewing angle characteristic of an LCD device in a diagonal direction is lowered due to light leakage occurring in the diagonal direction. More concretely, as shown in FIG. 2, a general IPS-mode LCD device comprises an LCD panel 101, and first and second polarizers 152 and 154 attached to upper and lower surfaces of the LCD panel 101, for linearly-polarizing light incident onto or emitted from the LCD panel 101.

In a normally black mode, polarization axes of the first and second polarizers 152 and 154 attached to the upper and lower surfaces of the LCD panel 101 are perpendicular to each other. Accordingly, light having passed through the first polarizer 152 is linearly-polarized in an X-axis direction to be introduced into the LCD device. When no signal is applied to the LCD panel 101, liquid crystal molecules 142 of the LCD panel 101 are aligned in the X-axis direction. Accordingly, light incident onto the LCD panel 101 passes through the LCD panel 101 with a linearly-polarized state in the X-axis direction. The polarization axis of the second polarizer 154 attached to the upper substrate is perpendicular to a polarizing direction of light having passed through an LC layer. Accordingly, light is completely absorbed by the polarizer of the upper substrate, but is not emitted out of the second polarizer 154. This may allow a normally black mode to be implemented.

However, when the LCD device is seen from a diagonal direction, polarizing directions of the first and second polarizers 152 and 154 are not perpendicular to each other, substantially. More concretely, polarizing directions of the first and second polarizers 152 and 154 are perpendicular to each other when the LCD device is seen from the front side, while the perpendicular state is not maintained any longer when the LCD device is seen from a diagonal direction.

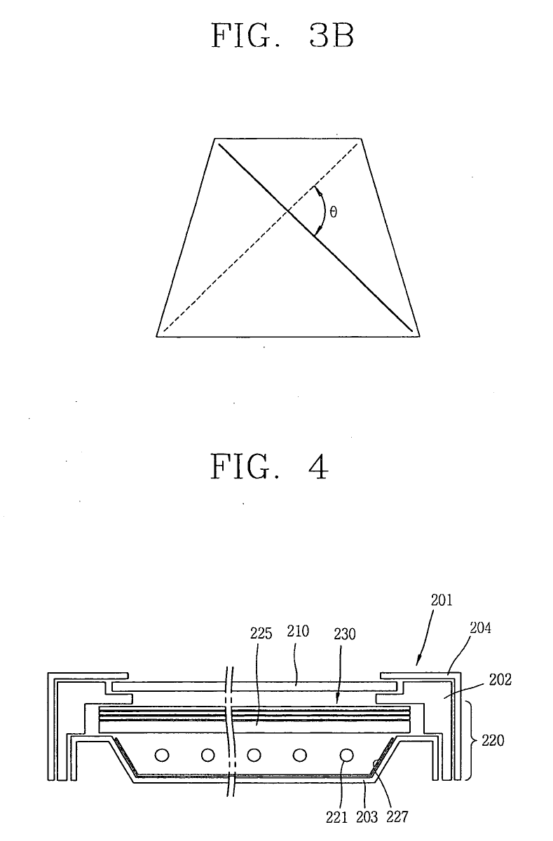

FIG. 3A is a view showing an arrangement of polarization axes of the first and second polarizers 152 and 154 on a path of light vertically passing through a screen of the LCD device, i.e., when the LCD device is seen from the front side. And, FIG. 3B is a view showing an arrangement of the polarization axes of the first and second polarizers 152 and 154 on a path of light passing through the screen of the LCD device at a predetermined polar angle and a predetermined azimuthal angle, i.e., when the LCD device is seen from a diagonal direction. Here, the dotted line indicates a direction of the polarization axis (absorption axis) of the first polarizer 152, whereas the solid line indicates a direction of the polarization axis (absorption axis) of the second polarizer 154.

Referring to FIG. 3A, when the LCD device is seen from the front side (i.e., when light passes through the screen of the LCD device in a vertical direction), the polarization axes of the first and second polarizers 152 and 154 are perpendicular to each other. However, referring to FIG. 3B, when the LCD device is seen from a diagonal direction (i.e., when light passes through the screen of the LCD device at a predetermined polar angle and a predetermined azimuth angle), the polarization axes of the first and second polarizers 152 and 154 are arranged to have a predetermined angle (θ) therebetween rather than 90°.

The polarization axes of the first and second polarizers 152 and 154 are not perpendicular to each other when the LCD device is seen from a diagonal direction. Accordingly, light having passed through the LCD panel 101 after being linearly-polarized by the first polarizer 152 is not completely absorbed by the second polarizer 154, but partially passes through the second polarizer 154. As a result, when the LCD device is seen from a diagonal direction even in a normally black mode, a complete black state can not be maintained due to partial light leakage. This light leakage in a diagonal direction mostly occurs in an LCD device having LEDs as an optical source of a backlight unit, and supplying light emitted from the LEDs to some parts of an LCD panel. In the present invention, the conventional partial light leakage occurring when the LCD device is seen from a diagonal direction in a normally black mode is prevented, by properly combining a plurality of optical sheets and the polarizers with one another, and thus by changing brightness and a polarization state of light passing through the optical sheets and the polarizers.

FIG. 4 is a view showing a structure of an LCD device according to the present invention;

In the present invention, as an optical source of the backlight unit, LEDs are used for convenience. However, the present invention is not limited to this.

Referring to FIG. 4, an LCD device 201 largely consists of a liquid crystal (LC) panel 210, and a backlight unit 220 installed on a rear surface of the LCD panel 210 for supplying light to the LCD panel 210. Although not shown, the LCD panel 210 for substantially implementing an image includes upper and lower substrates such as glass, and an LC layer disposed between the upper and lower substrates. Especially, the lower substrate is a thin film transistor (TFT) substrate where a driving device (e.g., a TFT) and a pixel electrode are formed, whereas the upper substrate is a color filter substrate where a color filter layer is formed.

The backlight unit 220 includes a plurality of LEDs 221 for substantially emitting light; a substrate 227 such as a printed circuit board or a frame, having the LEDs 221 mounted thereon and supplying a signal to the LEDs 221; a diffusion plate 225 for diffusing the light emitted from the LEDs 221; and optical sheets 230 disposed on the diffusion plate 225 for supplying light having enhanced and uniform brightness to the LCD panel 210 by re-diffusing the light emitted from the diffusion plate 225 and collecting the re-diffused light.

The LCD panel 210 and the backlight unit 220 are fixed to a main supporting portion 202, respectively, and are assembled to each other by a lower cover 203 and an upper cover 204.

The diffusion plate 225 serves to allow light having a uniform brightness to be incident onto the LCD panel 210 by diffusing light incident onto the LEDs 221. Here, a light guide plate may be used instead of the diffusion plate 225.

As the optical sheets 230 for enhancing efficiency of light incident thereon through the diffusion plate 225 or the light guide plate, a diffusion sheet, a prism sheet, a micro lens film, a dual brightness enhanced film, etc. are combined to each other.

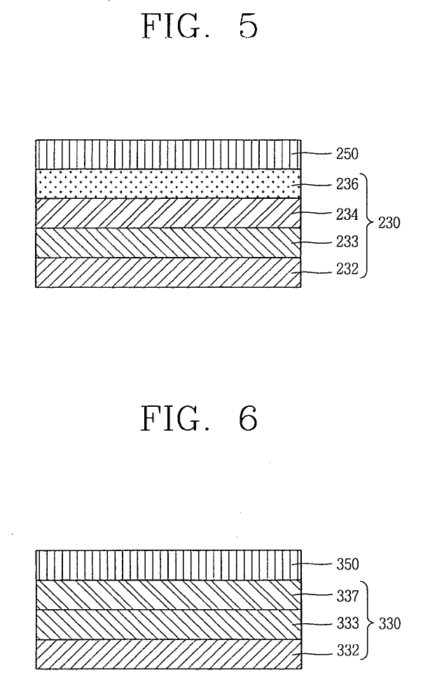

FIG. 5 is a view showing a structure of the optical sheets 230 of the backlight unit according to a first embodiment of the present invention.

As shown in FIG. 5, the optical sheets 230 are disposed below a polarizer 250. The polarizer 250 is composed of a zero retardation triacetyl cellulose (TAC) film having no phase difference (Rth). Although not shown, an analyzer is positioned to face the polarizer 250 in a state that the LCD panel 210 is disposed therebetween, and is configured to polarize light having passed through the LCD panel 210. The analyzer is also composed of a zero retardation TAC film having no phase difference (Rth).

The optical sheets include a diffusion sheet 232 for diffusing light emitted from the LEDs 221 serving as an optical source, a first prism sheet 233 for enhancing brightness of the light diffused by the diffusion sheet 232 to be incident thereon by collecting the light to the front side, a second prism sheet 234 for re-collecting the light collected by the first prism sheet 233 to the front side by refraction, and a micro lens film for refracting the light incident thereon from the second prism sheet 234.

The diffusion sheet 232 serves to diffuse light emitted from the diffusion plate 225 or the light guide plate, thereby having a uniform brightness. And, the diffusion sheet 232 is fabricated by distributing spherical-shaped seeds formed of acryl resin on a base film formed of polyester (PET). That is, light emitted from the diffusion plate 225 is diffused by the spherical-shaped seeds thus to have a uniform brightness.

The first prism sheet 233 and the second prism sheet 234 serve to collect light by refracting light incident thereon to the front side. And, the first prism sheet 233 and the second prism sheet 234 are fabricated by regularly implementing prisms formed of acryl resin on a base film formed of polyester (PET). The prisms on the first and second prism sheets 233 and 234 have triangular sectional surfaces, and are extending from one side to another side. Here, the prisms on the first prism sheet 233 are arranged in a vertical direction, whereas the prisms on the second prism sheet 234 are arranged in a horizontal direction. Under these structures, light is refracted to be collected to a vertical direction by the prisms on the first prism sheet 233 in a vertical direction. And, the light collected to the vertical direction is refracted to be collected to a horizontal direction. Accordingly, the light is collected to the front side.

The prisms on the first prism sheet 233 may be arranged in a horizontal direction, whereas the prisms on the second prism sheet 243 may be arranged in a vertical direction. The prisms on the first prism sheet 233 and the second prism sheet 234 may be arranged in any directions only if they are perpendicularly arranged to each other to enhance brightness of incident light by refracting the light to the front side.

The micro lens film 236 serves to enhance brightness of incident light by refracting the light by using a refractive index difference between material inside a micro lens and material outside the micro lens, the lens formed on a film in a concaved or convexed shape and containing material therein. +

Light emitted from the LEDs 221 is incident onto the diffusion sheet 232 to be diffused, and then is made to be incident onto the first prism sheet 233 and the second prism sheet 234. Then, the light is refracted into a vertical direction by the first prism sheet 233 to be collected. And, the light collected to a vertical direction is refracted into a horizontal direction by the first prism sheet 234 to be collected to the front side.

Then, the light collected by the first prism sheet 233 and the second prism sheet 234 is refracted by the micro lens film 236 to be supplied to the LCD panel 210.

FIG. 6 is a view showing a structure of optical sheets according to a second embodiment of the present invention.

A polarizer 350 disposed on optical sheets 330 consists of a zero retardation TAC film having no phase difference (Rth), and a phase difference film. And, an analyzer facing the polarizer 350 in a state that the LCD panel is disposed therebetween is also composed of a zero retardation TAC film having no phase difference (Rth).

Referring to FIG. 6, the optical sheets 330 include a first diffusion sheet 232 for diffusing light emitted from LEDs serving as an optical source of the backlight unit, a second diffusion sheet 333 for implementing a uniform brightness of the light diffused by the first diffusion sheet 332 to be incident thereon by re-diffusion, and a dual brightness enhanced film 337 for enhancing brightness of the light diffused by the first and second diffusion sheets 332 and 333 to be incident thereon.

The first and second diffusion sheets 332 and 333 serve to implement a uniform brightness by diffusing light emitted form the diffusion plate or the light guide plate. And, the first and second diffusion sheets 332 and 333 are fabricated by distributing spherical-shaped seeds formed of acryl resin on a base film formed of polyester (PET). Accordingly, incident light is diffused by the spherical-shaped seeds.

The dual brightness enhanced film 337 is implemented by providing a diffusion function to two sides of a reflection type polarization film, which serves to enhance brightness of incident light by about two times. Especially, a dual brightness enhanced film-diffuser (DBEF-D) rather than a DBEF-E or a DBEF-M is used in the present invention. The DBEF-D is formed by bonding diffusion films formed of polycarbonate (PC) to two sides of a DBEF. The dual brightness enhanced film 337 serves to enhance brightness by reflecting light incident thereon without having passed through the LCD panel, to the LCD panel.

In the present invention, as shown in FIG. 5, the optical sheets may be formed by sequentially implementing the micro lens film, the prism sheet (vertical), the prism sheet (horizontal), and the diffusion sheet in a combination manner. Alternatively, as shown in FIG. 6, the optical sheets may be formed by sequentially implementing the dual brightness enhanced film, the diffusion sheet, and the diffusion sheet in a combination manner. Under these configurations, a state of light supplied to the LCD panel is changed, thereby preventing the occurrence of mura on the LCD panel.

Table 1 shows experimental results for cross patterns and texts displayed on the LCD panel when the backlight unit of the present invention has been applied to the LCD device. Here, the patterns and texts displayed on the LCD panel were viewed from a diagonal direction where a polar angle is 65° and an azimuthal angle is 45°.

TABLE 1

| | | Cross Patterns | | Texts | | Average | |
|---|---|---|---|---|---|---|---|
| Optical | Light | Deterioration | Decision | Deterioration | Decision | Deterioration | Decision |
| Sheets | Leakage | Ratio | (25%) | Ratio | (25%) | Ratio | (25%) |
| 1 | 0.7 | 10% | OK | 5% | OK | 8% | OK |
| 2 | 2.3 | 30% | NG | 20% | OK | 25% | OK |
| 3 | 3.5 | 85% | NG | 90% | NG | 88% | NG |
| 4 | 4.4 | 95% | NG | 80% | NG | 88% | NG |
| 5 | 6.5 | 100% | NG | 100% | NG | 100% | NG |
| 6 | 9.2 | 95% | NG | 100% | NG | 98% | NG |

Referring to Table 1, the deterioration ratio indicates a degree that a viewer recognizes deteriorated quality of a screen due to mura occurred on the screen. Generally, the viewer scarcely recognizes mura on the screen when the deterioration ratio is less than 25%, whereas the viewer is able to recognize mura on the screen when the deterioration ratio is more than 25%. Accordingly, an LCD device having the deterioration ratio more than 25% is determined as an inferior one (NG), whereas an LCD device having the deterioration ratio less than 25% is determined as a normal one (OK). And, when light leakage is less than about 2 nit, the viewer scarcely recognizes the light leakage. On the contrary, when light leakage is more than about 2 nit, the viewer is able to recognize the light leakage.

Referring to Table 1, the optical sheet 1 indicates the optical sheet of the backlight unit shown in FIG. 5, and the optical sheet 2 indicates the optical sheet of the backlight unit shown in FIG. 6. The optical sheet 3 has the same structure as the optical sheet 2 (dual brightness enhanced film/diffusion sheet/diffusion sheet) except for the following. The optical sheet 2 includes a polarizer composed of a zero retardation TAC film having no phase difference (Rth) and a phase difference film, and an analyzer composed of a zero retardation TAC film having no phase difference (Rth). However, the optical sheet 3 includes a polarizer composed of a zero retardation TAC film having no phase difference (Rth), and an analyzer composed of a general retardation TAC film.

The optical sheet 4 has a structure of (dual brightness enhanced film/prism sheet (H)/diffusion sheet, and includes a polarizer and an analyzer each composed of a zero retardation TAC film having no phase difference (Rth). The optical sheet 5 has a structure of (dual brightness enhanced film/prism sheet (H)/diffusion sheet, and includes a polarizer and an analyzer composed of a zero retardation TAC film having no phase difference (Rth) and a general retardation TAC film, respectively.

And, the optical sheet 6 has a structure of (dual brightness enhanced film/diffusion sheet/diffusion sheet, and includes a polarizer and an analyzer composed of a zero retardation TAC film having no phase difference (Rth) and a general retardation TAC film.

Referring to Table 1, the optical sheet 1 shown in FIG. 5 (diffusion sheet/prism sheet (vertical)/prism sheet (horizontal)/micro lens film) has light leakage of about 0.7 nit in a diagonal direction. And, the deterioration ratio with respect to cross patterns is 10%, and the deterioration ratio with respect to texts is 5%, thereby having the average deterioration ratio of about 8%. Accordingly, light leakage scarcely occurs at the optical sheet 1 of FIG. 5 in a diagonal direction, and the viewer scarcely recognizes mura on the screen. The optical sheet 1 of FIG. 5 allows the viewer to scarcely recognize mura in a diagonal direction (i.e., mura is almost removed), thereby greatly enhancing picture quality of the LCD device.

The optical sheet 2 shown in FIG. 6 (dual brightness enhanced film/diffusion sheet/diffusion sheet) has light leakage of about 2.3 nit in a diagonal direction. And, the deterioration ratio with respect to cross patterns is 30%, and the deterioration ratio with respect to texts is 20%, thereby having the average deterioration ratio of about 25%. Accordingly, even if light leakage occurs at the optical sheet 2 of FIG. 6 in a diagonal direction, the viewer scarcely recognizes the light leakage. This may allow the viewer to scarcely recognize mura on the screen. The optical sheet 2 of FIG. 6 allows the viewer to scarcely recognize mura in a diagonal direction (i.e., mura is almost removed), thereby greatly enhancing picture quality of the LCD device.

On the other hand, the optical sheets 3 to 6 having different structures from the optical sheets 1 and 2 of the present invention have light leakage more than 3.5 nit in a diagonal direction. This may cause the viewer to definitely recognize the light leakage in a diagonal direction. Furthermore, since the average deterioration ratio is more than about 88%, the viewer can easily recognize mura on the screen. That is, in the case of using backlight units having the optical sheets 3 to 6, mura occurring on a screen in a diagonal direction is not removed to deteriorate picture quality of LCD devices.

In the present invention, the plurality of optical sheets are suitable combined to one another to prevent the occurrence of mura in a diagonal direction of the LCD device. Even if the used optical sheets are general ones, the optical sheets are suitable combined to one another as shown in Table 1. Accordingly, the optical sheets of the present invention may implement more enhanced effects than the other optical sheets.

The present invention discloses the optical sheets having a specific structure. However, the present invention is not limited to this. For instance, optical sheets may have any structures only if the optical sheets perform their own functions.

Furthermore, the present invention discloses the direct-type backlight unit using the LEDs. However, the present invention is not limited to this. For instance, the present invention may be also applied to a direct-type backlight unit or an edge-type backlight unit using Cold Cathode Fluorescent Lamps (CCFL) or External Electrode Fluorescent Lamps (EEFL). And, the present invention may be also applied to an edge-type backlight unit using LEDs.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A backlight unit, comprising:
an optical source for emitting light;
a diffusion sheet for diffusing the light from the optical source;
a first prism sheet for collecting the light to a front side to enhance brightness of the light diffused by the diffusion sheet;
a second prism sheet for refracting the light collected by the first prism sheet to re-collect the light to a front side; and
a micro lens film for refracting the light from the second prism sheet.

2. The backlight unit of claim 1, wherein the optical source includes a light emitting device (LED).

3. The backlight unit of claim 1, wherein the direction of prisms on the first prism sheet is perpendicular to the direction of prisms on the second prism sheets.

4. A liquid crystal display (LCD) device, comprising:
a liquid crystal display panel for displaying an image;
a backlight unit for supplying light to the LCD panel, and the backlight unit including an optical source, a diffusion sheet for diffusing the light from the optical source, a first prism sheet for collecting the light to a front side to enhance brightness of the light diffused by the diffusion sheet, a second prism sheet for refracting the light collected by the first prism sheet to re-collect the light to a front side, and a micro lens film for refracting the light from the second prism sheet;
a polarizer disposed between the LCD panel and the backlight unit, the polarizer including a zero retardation triacetyl cellulose (TAC) film having no phase difference (Rth); and
an analyzer facing the polarizer in which the LCD panel is sandwiched therebetween, the analyzer including a zero retardation TAC film having no phase difference (Rth).

5. A backlight unit, comprising:
an optical source;
a first diffusion sheet for diffusing light incident from the optical source;
a second diffusion sheet for diffusing the light diffused by the first diffusion sheet to uniform the brightness of the light; and
a dual brightness enhanced film for enhancing brightness of the light diffused by the first and second diffusion sheets.

6. The backlight unit of claim 5, wherein the optical source includes a light emitting device (LED).

7. A liquid crystal display (LCD) device, comprising:
a liquid crystal display panel for displaying an image;
a backlight unit for supplying light to the LCD panel, the backlight unit including an optical source, a first diffusion sheet for diffusing light incident from the optical source, a second diffusion sheet for diffusing the light diffused by the first diffusion sheet to uniform the brightness of the light, and a dual brightness enhanced film for enhancing brightness of the light diffused by the first and second diffusion sheets;
a polarizer including a zero retardation triacetyl cellulose (TAC) film having no phase difference (Rth) and a phase difference film; and
an analyzer facing the polarizer in which the LCD panel is sandwiched therebetween, the analyzer including a zero retardation TAC film having no phase difference (Rth).
